(19) United States
(12) Patent Application Publication
(10) Pub. No.: US 2007/0220566 A1
(43) Pub. Date: Sep. 20, 2007

(54) Method and system of distributing media content and generating playlists

(75) Inventor: Ty O. Ahmad-Taylor, New York, NY (US)

Correspondence Address: BROOKS KUSHMAN P.C., 1000 TOWN CENTER, TWENTY-SECOND FLOOR, SOUTHFIELD, MI, 48075, US

(73) Assignee: Comcast Cable Holdings, LLC, Philadelphia, PA (US)

(21) Appl. No.: 11/367,157

(22) Filed: Mar. 3, 2006

(51) Int. Cl. H04N 7/173; H04N 5/445; G06F 3/00

(52) U.S. Cl. 725/89; 725/58; 725/97; 725/90; 725/88

(57) ABSTRACT

Method and system of distributing content and generating playlists to facilitate playback and distribution of the content. The method and system permitting a user to select multiple pieces of content for inclusion within a playlist and thereafter facilitating distribution of the specified content to the user for playback according to an order specified in the playlist.

### BACKGROUND OF THE INVENTION

1. Field of the Invention

The present invention relates to methods and system of distributing content and generating playlists.

2. Background Art

Media content providers, such as cable, broadcast, satellite, high-speed data, and the like, provide content to a number of subscribers for playback. The subscribers, in some case, may desire particular content for playback. One problem media providers face is how to provide subscribers with an ability to select particular content for playback.

### SUMMARY OF THE INVENTION

One non-limiting aspect of the present invention relates to providing subscribers with an ability to select content for playback.

One non-limiting aspect of the present invention relates to a method of scheduling playback of television programs available through a television system. The method may include determining a number of programs available for viewing through the television system, receiving user selection of at least two of the programs, associating the selected programs with a playlist, and facilitating playback of the programs specified within the playlist.

The method may include compiling the programs specified in the playlist one single media device associated with a user making the user selections and coordinating playback of the compiled programs therefrom, such as by compiling the programs at an on demand server or headend located remotely from the user and/or compiling the programs at a home network of the user.

The method may include sourcing at least two of the programs from different media devices, including successively streaming the programs from each media device according to an order specified in the playlist.

The method may include determining the number of programs available for viewing as a function of programs specified in a secondary playlist, including specifying the programs included with the secondary playlist as a function programs identified in a friend's playlist, an editorial playlist, or a dynamic community playlist.

The method may include determining the number of programs available for viewing as a function of programs stored on media devices connected to a home network associated with a user selecting the programs included within the playlist.

The method may include determining the number of programs available for viewing as a function of programs stored on a home network of a friend of a user selecting the programs included within the playlist. Optionally, the method may include authenticating access to the home network of the friend prior to determining the programs available thereon to be available for viewing by the user.

The method may include determining the number of programs available for viewing as a function of programs available on demand from a cable headend associated with the media device.

The method may include comprising determining the number of programs available for viewing as a function of a subscription associated with a user selecting the programs included within the playlist.

The method may include determining the number of programs available for viewing as a function of search criteria.

The method may include storing the playlist for subsequent use in facilitating playback of programs specified therein.

The method may include skipping over programs specified within the playlist that are no longer available.

The method may include receiving the user selection of programs through an electronic programming guide displayed on a television used to playback the programs.

One non-limiting aspect of the present invention relates to a user interface for use by a user in generating a playlist, the playlist specifying content available for playback on a media device connected to a home network of the user. The user interface may include a source portion for indicating an number of sources having content suitable for inclusion within the playlist, wherein each of the sources are separate media devices having capabilities for electronically communicating with the home network of the user.

The user interface may further include an available content portion for listing content available from one or more sources in the source portion and a playlist portion for listing content selected from the available content portion for inclusion within the playlist.

Optionally, at least one of the sources may be associated with content located remotely from the home network of the user, a friend of the user, and/or a premium source, the premium sources requiring payment prior to permitting playback of the content associated therewith.

The above features and advantages, along with other features and advantages of the present invention, are readily apparent from the following detailed description of the invention when taken in connection with the accompanying drawings.

### BRIEF DESCRIPTION OF THE DRAWINGS

The present invention is pointed out with particularity in the appended claims. However, other features of the present invention will become more apparent and the present invention will be best understood by referring to the following detailed description in conjunction with the accompany drawings in which:

FIG. 1 illustrates a system for providing media content in accordance with one non-limiting aspect of the present invention;

FIG. 2 illustrates an exemplary home network of one of the subscribers in accordance with one non-limiting aspect of the present invention;

FIG. 3 illustrates a flowchart of a method for distributing media content in accordance with one non-limiting aspect of the present invention; and

FIG. 4 illustrates a user interface for generating a playlist in accordance with one non-limiting aspect of the present invention.

### DETAILED DESCRIPTION OF THE PREFERRED EMBODIMENT(S)

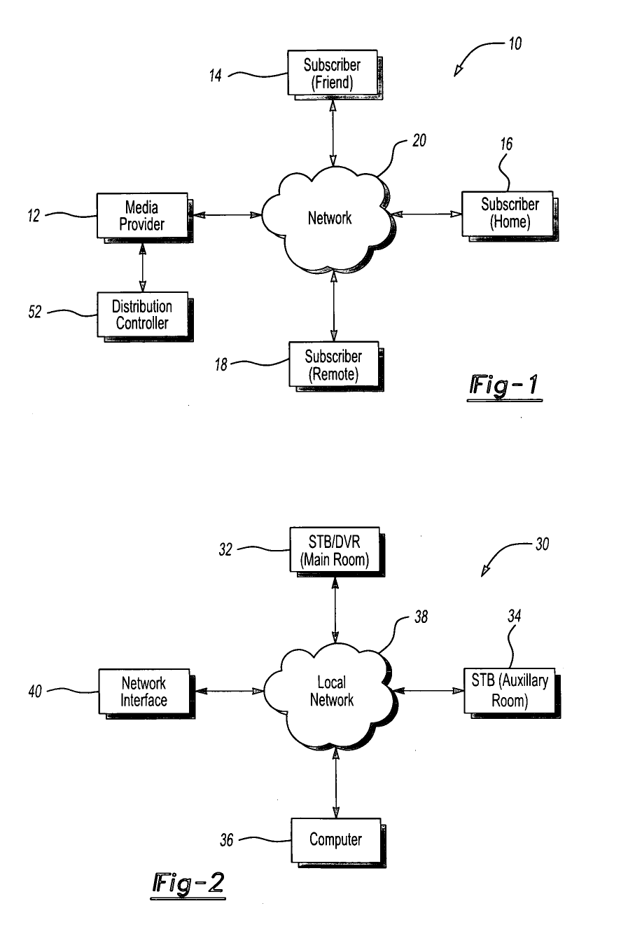

FIG. 1 illustrates a system 10 for providing media content in accordance with one non-limiting aspect of the present invention. The system 10 includes a media provider 12 for providing media services to subscribers at one or more subscriber locations 14-18 and a network 20 for facilitating communications there between.

The media provider 12 may be associated with any number of service providers, such as cable, broadcast, and satellite television, high-speed data, telecommunication, and the like. The media provider 12, for exemplary purpose, is most prominently described with respect to being a cable television service provider having capabilities for providing cable television, telecommunications, and high-speed data services, however, the present invention is not intended to be so limited.

The media service provider 12 may be configured to support and/or facilitate the use of any number of television and non-television services and applications, such as, but not limited to, linear and non-linear television programming (cable, satellite, broadcast, etc.), Video on Demand (VOD), interactive television (iTV), interactive gaming, pay-per-view (PPV), digital video recording (local and remote), and others.

The network 20 may include any number of features and devices to facilitate signal transportation and other operations associated with interfacing the subscriber locations 14-18 with each other and the services associated with the media provider 12. The network 20 may include terrestrial and extraterrestrial components and infrastructures. It may include cable lines, telephone lines, and/or satellite or other wireless architectures. The network 20 may be associated with other private and/or public networks, such as the Internet and provider specific private networks.

For example, one or more of the network support features may be a headend, router, hub, switch, gateway, conditional access router (CARs), cable modem terminations system (CMTSs), network provisioning unit (NPUs), session boarder controller, media gateway, media gateway controller, signaling gateway, call management server, presence server, SIP routing proxy, SIP proxy/registrar server, PCMM policy server, bandwidth on demand server, streaming server caching proxy, gaming server, CDN, media acquisition server, provider server, a unified messaging server, OSS/BSS, global directory server, digital or personal video recorder (DVRs, PVRs), media terminal adapter (MTA), and/or outlet digital adapter (ODA).

Each subscriber location may include one or more media devices to facilitate user interaction with the media content/services. The scope of such interaction may be based on subscriptions and other parameters set by the media provider 12. The subscriptions may specify various classes of services and other parameters associated with usage rights and services available to the corresponding subscriber.

The media devices may relate to any number of devices suitable for interfacing and/or facilitating interfacing the subscribers, For example, the media devices may be a settop box (STB), digital video recorder (DVR), personal computer (PC), television (which may include embedded user interface and processing capabilities), outlet digital adapter (ODA), media terminal adapter (MTA), cable modem (CM), personal digital assistant (PDA), computer, mobile device (phone, computer, etc.), and any other item having capabilities to supporting access to any number of services.

The media devices may be configured to descramble and to support and/or facilitate the use of any number of television and non-television related signals, such as, but not limited to, Hyper Text Transfer Protocol (HTTP), Dynamic Host Configuration Protocol (DHCP), Syslog, Simple Network Management Protocol (SNMP), Trivial File Transfer Protocol (TFTP), Data Over Cable Service Interface Specification (DOCSIS), Domain Name Server (DNS) applications, DOCSIS Settop Gateway (DSG), out-of-band (OOB) messaging, and others.

FIG. 2 illustrates an exemplary home network 30 of one of the subscribers 16 in accordance with one non-limiting aspect of the present invention. The home network 30 may include any number of media devices 34-36 connected to each other through a local network 38. The local network 38 may be configured to facilitate communications between the media devices 34-36, which for exemplary purposes are shown to be a STB/DVR in a main room of the subscriber's home, a STB in an auxiliary room, and a personal computer in another room.

The local network 38 may be a wireline or wireless network setup by the subscriber and/or the media service provider within the subscriber's home. A network interface 40 may be included for separating and interfacing the local network 38 with the larger network 20 associated with the media service provider 12. The network interface 40 feature may be a standalone feature, such as a router, and/or a feature integrated with one of the other media devices 32-36, such as with one of the STBs. Of course, in some application, the network interface 40 not be unnecessary.

The home network 30 is generally characterized as a closed system such that the media devices 32-36 connected thereto are free to share information and data with each other without concern of interception by remote devices, i.e., those separated by the network interface 40. Each of the media devices 32-36 may include suitable interfaces and protocols for facilitating communication with each other, such as to facilitate peer-to-peer and other file sharing operations.

Advantageously, this arrangement allows the subscriber 16 to view programs recorded on the STB/DVR or other device at any one of the media devices 32-36 connected to the local network 38. Of course, the present invention is not limited to only closed systems and fully contemplates the use of less or more secure networks to facilitate communications between the various media devices 32-36 of the subscriber.

The system 10 shown in FIG. 1 may be used to provide media content to one or more of the subscribers, as briefly mentioned above. The media content may relate to live and/or on-demand viewing/streaming/broadcasting of television programs, movies, audio, and other multimedia, as well as, downloading of clips or full-length versions of the same. The source of this content may be the media provider 12 (which in turn may receive the content from other sources) and/or one or more of the subscriber devices or other non-subscriber devices connected to one of the networks 20, 38.

For example, if the media provider 12 is a television service provider, a portion of the media content may relate to television programs, movies, and other multimedia packets. This content may be delivered from the media service provider 12 to the subscribers through streaming, downloading, broadcast, peer-to-peer, and any number of other processes. The media content may be delivered directly from the media service provider and/or from one or more of the other devices in communication therewith.

In more detail, as is common with larger media content providers, multiple regional enterprises, such as headend units and the like, may be configured to provide regional programming to a number of subscribers associated therewith. Each of the headends may store various types of media content for distribution to the subscribers it services. Optionally, the headends may be configured to support headend to headend communications such that non-direct subscribers that are supported by other headends may similarly receive content.

In addition, some of the media content may be sourced from the subscribers 14-18 themselves, such as by transporting content stored locally on the home networks of the subscribers to other locations within the same home network and/or to other locations beyond the home network that may be in communication thereto by way of the larger network 20. The media provider may include features and capabilities to facilitate such inter-subscriber communications.

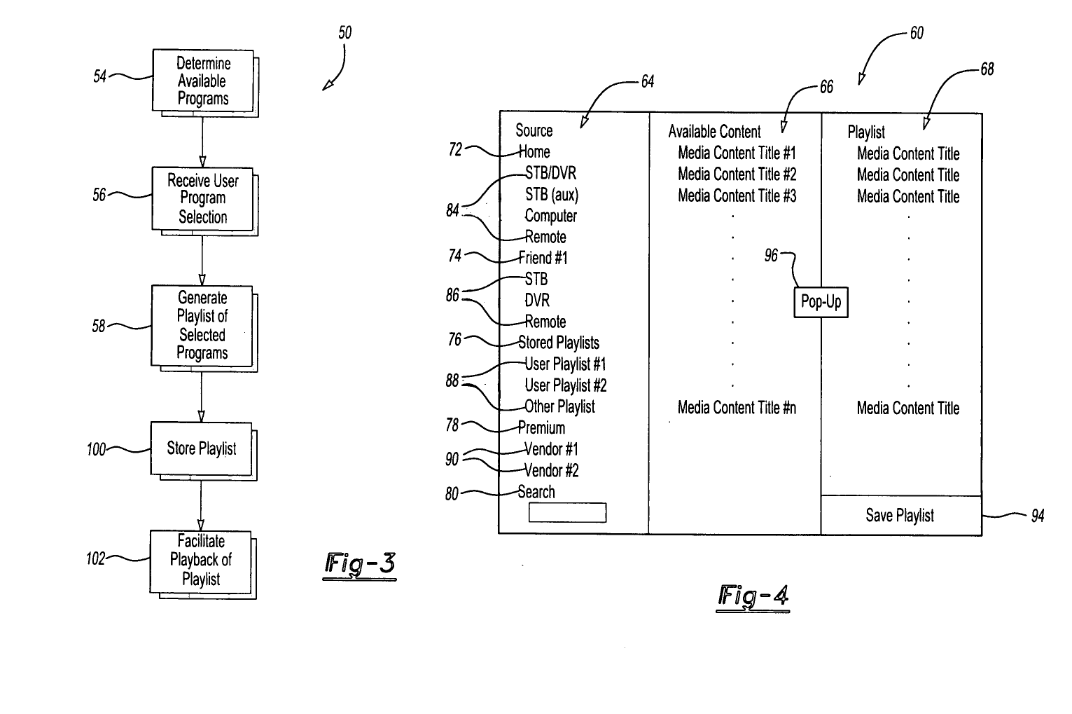

Furthermore, the media content provider 12 may include software, applications, and other logic to facilitate the distribution and playback of the media content between any of the features, devices, and elements within the system. FIG. 3 illustrates a flowchart 50 of method for distributing such media content in accordance with one non-limiting aspect of the present invention.

The method may be embodied and executed according to instructions or other executable logic included within a computer-readable medium associated with the media provider 12 and/or other feature in the system. Any number of applications or other executable features may be provided and/or supported by the media provider 12 and/or otherwise obtained to support the operations and functions associated with the method of the present invention.

A distribution controller 52 may be associated with the media provider 12 and/or provided by a vendor to support one or more of the operations associated with the method of the present invention. The distribution controller 52 may include any number of capabilities associated with implanting the processes, function, and other operations required to execute the method of the present invention.

Block 54 relates to determining media content available for distribution. The term media content is intended to refer to any identifiable set of media or program, such as a television program, movie, video clip, audio clip, static image, advertisement, and the like. One aspect of determining the available media content may include identifying the subscriber requesting distribution.

In more detail, a web page, portal, electronic programming guide, or other user interface may be supported by the distribution controller 52 for access by the subscribers for requesting media content distribution. The subscribers may log into the portal and/or be automatically logged in through a STB, computer, or other feature so as to facilitate their identification. The distribution controller 52 may directly support the user interface and/or facilitate its support by directly the user accessing media device to download an application for displaying the user interface locally.

The media content available to the identified subscriber may be determined according to any number of variables. For example, the available content may relate to content available from the media provider, such as freely available network television programs and the like, subscriber subscriptions, such as premium channels, program/movie packages, pay-per-view, video on-demand, previously stored/purchased content, and the like.

Other available content may be determined as a function of content stored locally on the media devices associated with the subscriber's home network, such as previously purchased content and/or locally added content, such as home movies, digital pictures, and the like that the subscriber may have directly added to a home computer or other local storage device. Similarly, content available stored on media devices associated with a friend's home network or from another entity remote from the subscriber may be available.

Yet other available media content may be determined as a function of content previously stored by the subscriber and/or the subscriber's friends on a remote storage device, i.e., a storage device located remotely for one of the home networks. For example, as VOD and other on-demand platforms develop, media service providers may provide capabilities for subscribers to store content on local headends or other media service provider storage elements. The media content may be stored through DVR-like operations, such as through user selected program recording, up-loaded thereto by the subscriber, and/or any number of other means.

The media provider may be configured to poll the subscriber's home network, the home networks of the subscribers friends, and other locations, such as a VOD server and the like, to determine the available media content. Likewise, a locally operable application may communicate from the subscriber's home network with the subscriber's other home-based media devices and friend's home network to determine the content available therefrom. Of course, any number of other methods and processes may be used to locate and determine the available media content, regardless of the source of the media content.

Optionally, the media service provider 12, as described below in more detail, may include features to facilitate translating and/or otherwise manipulating the available content to formats suitable for transportation and distribution between media devices and any one of the networks 20, 38. The media service provider may also include features and capabilities for tracking multiple sources of the media content and coordinating addressing needed to distribute the media content from the source to the requesting subscriber.

Block 56 relates to receiving user selection of the available media content. The selected media content may be added to a playlist or other feature associated with the user making the selections. (A subscriber may relate to an entity, such as a home, and a user may correspond with one of the users authorized for use under the corresponding subscriber, i.e., a member of the home.) Depending on the configuration of the user interface displaying the available media content, the user may select the media content by clicking on a corresponding title, dragging the title to another portion of the screen, and/or by performing other operations.

Block 58 relates to generating a playlist of the available content based on the selections made by the user. The playlist is intended to refer to any suitable schedule or organization of information that can be used to sequentially or otherwise continuously playback the content associated therewith, as one having ordinary skill in the art will appreciate. The distribution controller 52 or other entity may store the playlist for subsequent use in playing back the content specified therein. Addressing and other communication and non-communications information and data may be included with the playlist to facilitate locating the sources (media devices) associated with the specified content and distributing the specified content for play back therefrom.

FIG. 4 illustrates a user interface 60 for generating a playlist in accordance with one non-limiting aspect of the present invention. The user interface 60, as described above, may be provided by the distribution controller 12 and/or otherwise provided to the subscriber, such as through a downloadable application. It may be accessed through a web page, such as from a computer, and/or through electronic programming guide (EPG) or other feature accessible through the subscriber's media devices. The user interface 60 may be a standalone user interface and/or integrated into other user interfaces and applications.

As shown, the user interface 60 includes a source portion 64, available content portion 66, and playlist portion 68. The source portion 64 lists a number of source categories 72-80 and sources (media devices) 84-90 associated therewith that are available to the subscriber, and/or users associated with the subscriber if the subscriber includes multiple users. The user may click or otherwise highlight one of the sources 84-90 to display the media content available therefrom within the available content portion 66. Titles associated with the corresponding content may be displayed and selected for import into the playlist portion 68.

Multiple titles may be selected from multiple sources 84-90 and added to the playlist. The order of the selected titles may be adjusted through dragging and dropping operations. Once completed, a save button 94 may be provided to save the playlist and assign a title thereto. Optionally, as shown with in the source portion 64, multiple user playlists 88 may be saved for each user in this manner. As described below in more detail, the playlist may then be used by the user and/or sent to a friend or other user to facilitate playback of the content specified therein.

Each of the sources 84-90 listed in the source section may be selected to display the content available therefrom, if the user is authorized to access and view the content. As shown, one of the sources is designated as home network of the user and indicates the media devices within the subscriber's home that include available content. Likewise, content available from a friend of the subscriber/user may be similarly displayed for selection.

An authentication sequence or other security measure may be added to prevent unauthorized access to any of the sources, such as a by requiring password or personal identification number. This information can be added through a pop-up window 96 or other feature in the user interface, either prior to listing the available content and/or after permitting the selection thereof.

Optionally, the stored playlists 88 may be sent to the user, such as those made available by a friend and/or those available from other secondary playlist sources. For example, canned or other predefined playlists may be provided by and/or on the behalf vendors and/or other entities associated with the available content. For example, a program playlist may be used for a particular television program to list available episodes or a series of movies within a particular genre or viewing profile of the subscriber/user.

Furthermore, the sources may be associated with a premium channels or services. For example, many cable operators sell subscription and pay-per-purchase service for movie channels, music, data, and other files. The available content may be selected as a function of the subscriber's subscriptions and/or as a function of currently available pay-per-purchase offerings. The pop-up menu 96 or other feature may be displayed to indicate costs associated with such selections.

A search field 80 may also be included to permit the user to search for particular content. In some cases, and with the volume of available content being potentially large, it may be difficult to list all the content with the limited space of the user interface. The search field may be provided to enter search criteria used to locate particular content. Still further, a favorites menu (not shown) or similar feature may be include to list content believed to be relevant to the subscriber/user. This information may be displayed as a function of past viewing habits, searches, or other preferences.

The sources 84-90 are illustrated in a file-folder type arrangement where the user can select one of the headings to expand the sub-heading associated therewith. For example, the user may select the home heading to display the devices associated therewith, i.e., to expand the listing. An exemplary expanded form of each heading is shown in FIG. 4. Of course, the present invention is not intended to be limited to this method of listing available content and fully contemplates the use of any number of other user navigable features.

Advantageously, the-user interface 60 allows the user to view content available from any number of sources, including local and remote sources. The user may then individual select the sources 84-90 to display the content available therefrom. Thereafter, the available content may be further selected to inclusion within a savable playlist. The sources 84-90 may be specified by the user and/or pre-selected by the distribution controller 52 to permit generating a playlist having content from any source available to the user.

Block 100 relates to storing one or more playlists. The stored playlists may then be added to the source portion 88 of the user interface 60 for use in subsequent playlist generation. The stored playlist may also be distributed to friends and other individuals through email or other communication operations. For example, the present invention contemplates a dynamic community or editorial feature where various subscribers may post or other disseminate their playlist(s) to other subscribers. These playlists may be listed in the source portion of the user interface. Features may be provided to allow the community to post messages, rate, or otherwise comment on the community playlists.

Block 102 relates to facilitating playback of a one or more of the playlists associated with the subscriber/user. A separate user interface (not shown) may be provide to list available playlists and to activate the playback thereof and/or an additional menu or feature (not shown) may be included in the user interface 60 of FIG. 4. The playlist playback may occur through any number of operations and processes, depending on the configuration of the system 10 and the media device requesting the playback thereof.

For example, the playback may occur with the distribution controller 52 directing streaming or other broadcasting of the playlist specified content from the corresponding sources (which may be at different locations) to the requesting media device through linear and/or non-linear signaling. The order of playback may correspond with the order of the content as listed in the playlist, which can be adjusted as described above.

Optionally, the media content in the playlist may be downloaded and/or otherwise communicated to a headend serving the subscriber (or other media service provider supported feature) and/or to a media device at the subscriber location. Once all the desired content is collected at this single location, it may then be streamed or otherwise distributed to the user for playback.

Regardless of the source distributing the playlist specified media content, optional control features, such as pause, fast-forward, rewind, and the like, may be provided to facilitate playback. In addition, advertisements, pop-ups, and other features during may be inserted or otherwise associated with the playlist specified content, such as through instructions provided by the distribution controller. These features may then be played during playback of the playlist.

In some cases, and especially with older playlists, the content specified therein may no longer be available. The playlist portion of the user interface 60 may display such titles in phantom or through some other distinguishable marking. Optionally, if a playlist having unavailable content is selected, the remaining content may still be collected and distributed as described above such that the unavailable content is simply skipped over during playback. If the previously unavailable content subsequently becomes available, it may then be included during playback at its original location within the playlist.

As described above, the ability of users to generate customized playlists can be advantageous in permitting distribution of content from locations inside and outside of the home or other subscriber entity. In addition, such capabilities may be used to permit access to content from a remote location such as that associated with another subscriber. For example, if the user is at a media device associated with the remote subscriber 18, the user may identify themselves and coordinate playback of content specified in one of their playlists to a media device of the remote subscriber.

As required, detailed embodiments of the present invention are disclosed herein; however, it is to be understood that the disclosed embodiments are merely exemplary of the invention that may be embodied in various and alternative forms. The figures are not necessarily to scale, some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of scheduling playback of television programs available through a television system, the method comprising:
determining a number of programs available for viewing through the television system;
receiving user selection of at least two of the programs;
associating the selected programs with a playlist; and
facilitating playback of the programs specified within the playlist.

2. The method of claim 1 further comprising compiling the programs specified in the playlist on a single media device associated with a user making the user selections and coordinating playback of the compiled programs therefrom.

3. The method of claim 2 further comprising compiling the programs at an on demand server or headend located remotely from the user.

4. The method of claim 2 further comprising compiling the programs at a home network of the user.

5. The method of claim 1 further comprising sourcing at least two of the programs from different media devices.

6. The method of claim 5 further comprising successively streaming the programs from each media device according to an order specified in the playlist.

7. The method of claim 1 further comprising determining the number of programs available for viewing as a function of programs specified in a secondary playlist.

8. The method of claim 5 further comprising specifying the programs included with the secondary playlist as a function programs identified in a friend's playlist, an editorial playlist, or a dynamic community playlist.

9. The method of claim 1 further comprising determining the number of programs available for viewing as a function of programs stored on media devices connected to a home network associated with a user selecting the programs included within the playlist.

10. The method of claim 1 further comprising determining the number of programs available for viewing as a function of programs stored on a home network of a friend of a user selecting the programs included within the playlist.

11. The method of claim 10 further comprising authenticating access to the home network of the friend prior to determining the programs available thereon to be available for viewing by the user.

12. The method of claim 1 further comprising determining the number of programs available for viewing as a function of programs available on demand from a cable headend associated with the media device.

13. The method of claim 1 further comprising determining the number of programs available for viewing as a function of a subscription associated with a user selecting the programs included within the playlist.

14. The method of claim 1 further comprising determining the number of programs available for viewing as a function of search criteria.

15. The method of claim 1 further comprising storing the playlist for subsequent use in facilitating playback of programs specified therein.

16. The method of claim 1 further comprising skipping over programs specified within the playlist that are no longer available.

17. The method of claim 1 further comprising receiving the user selection of programs through an electronic programming guide displayed on a television used to playback the programs.

18. A user interface for use by a user in generating a playlist, the playlist specifying content available for playback on a media device connected to a home network of the user, the user interface comprising:
a source portion for indicating an number of sources having content suitable for inclusion within the playlist, wherein each of the sources are separate media devices having capabilities for electronically communicating with the home network of the user;
an available content portion for listing content available from one or more sources in the source portion; and
a playlist portion for listing content selected from the available content portion for inclusion within the playlist.

19. The user interface of claim 18 wherein at least one of the sources is associated with content located remotely from the home network of the user.

20. The user interface of claim 18 wherein at least one of the sources is associated with a friend of the user.

21. The user of interface of claim 20 wherein content available from the friend is listed in the available content portion only after successful completion of an authorization process, the authorization process approving the user to view content available from the friend.

22. The user interface of claim 18 wherein at least one of the sources is a premium source, the premium sources requiring payment prior to permitting playback of the content associated therewith.

23. The user interface of claim 22 further comprising a pop-up feature for displaying a cost associated with selecting content associated with one of the premium sources.
